(19) United States
(12) Patent Application Publication
(10) Pub. No.: US 2007/0105007 A1
(43) Pub. Date: May 10, 2007

(54) Dry impregnation of platinum on a carbon substrate

(75) Inventor: John R. Regalbuto, Glenview, IL (US)

Correspondence Address: GREER, BURNS & CRAIN, 300 S WACKER DR, 25TH FLOOR, CHICAGO, IL, 60606, US

(73) Assignee: The Board of Trustees of the University of Illinois

(21) Appl. No.: 11/361,753

(22) Filed: Feb. 24, 2006

Related U.S. Application Data
(60) Provisional application No. 60/736,093, filed on Nov. 10, 2005.

(51) Int. Cl. H01M 4/96; H01M 4/92; H01M 4/88; B05D 5/12

(52) U.S. Cl. 429/44; 502/101; 427/115; 427/125; 427/113

(57) ABSTRACT

This invention provides a method for preparing particles of a platinum metal element on a carbon substrate. An aqueous solution of a platinum metal element complex is prepared by dissolving the platinum metal element complex in water not exceeding the pore volume of the carbon substrate to be impregnated. The pH of the aqueous solution is adjusted if necessary, to a value of less than 2. A carbon substrate is dry impregnated with the aqueous solution and dried at ambient conditions. The platinum metal complex-loaded substrate is heated to a temperature of about 200° to 300° C. under reducing conditions. The platinum metal particles so formed are preferably about 15 to about 25 Å in diameter. The carbon substrate is used to make a carbon membrane or electrode having highly dispersed platinum metal elements of at least 120 m² Pt/g Pt at platinum metal loadings of at least 20%.

### CROSS REFERENCE TO RELATED APPLICATION

This application is a continuation-in-part of U.S. Provisional Ser. No. 60/736,093, entitled “DRY IMPREGNATION OF PLATINUM ON A CARBON SUBSTRATE”, filed Nov. 10, 2005, herein incorporated by reference.

### GOVERNMENT INTEREST

The present invention was made with the financial support of the National Science Foundation Grant CTS-9908181. The U.S. government has certain rights in this invention.

### BACKGROUND ART

Fuel cells offer efficient and environmentally friendly ways of producing energy compared to traditional internal combustion engines. For example, hydrogen fuel is reacted with oxygen from the atmosphere to produce energy. The reaction is very clean burning, with water as the only by-product. Two exemplary fuel cells that burn hydrogen include polymer electrolyte membrane cells and alkaline fuel cells. These two types of fuel cells use different electrolytes. The hydrogen fuel is reduced to hydrogen ions at the anode, then reacts with oxygen to form water at the cathode.

The so-called “Platinum Metal” elements that constitute the heavier six of the nine Group VIII elements include platinum, ruthenium, osmium, rhodium, iridium and palladium. Although platinum and palladium are especially known for their reflectance and relative stability toward oxidation, each member of this group of elements is separately useful as a catalyst for chemical reactions, particularly oxidation-reduction reactions as are used in fuel cells.

Illustratively, in many applications such as heterogeneous catalysts and fuel cell electrodes, small particles of platinum (Pt) are mounted, by numerous techniques, onto high surface area carbon “supports” or “substrates”. There are myriad companies working toward the development of fuel cell components, and particularly fuel cell electrodes. A commonly cited electrode producer is E-TEK Corporation. Large catalyst manufacturers such as Engelhard and Johnson Matthey are also developing fuel cell components, and numerous smaller ones. Carbon supported Pt and palladium (Pd) catalysts are used extensively in the chemical process industry for hydrogenation reactions, and many other specialty applications. There is also much interest in Pt/carbon electrodes and catalysts in academia.

Because of its expense, it is usually desired to have Pt in the form of very small particles, which maximizes the amount of exposed Pt surface to increase catalytic activity. This condition is known as high “dispersion.” Fuel cell applications require the use of high weight loadings of Pt at high dispersion. Present techniques have the ability to cause the deposit of large amounts of Pt onto high surface area carbon supports, but are cumbersome to use. Similar results are obtained using the other members of the platinum metal elements.

Impregnation of active metals onto catalyst supports is well known in the art. Strong electrostatic adsorption allows a dilute solution of the metals to be absorbed into the catalyst pores and deposit the metals on all surfaces of the catalyst. As will be recognized by those of ordinary skill in the art, dry impregnation, where the amount of water used for impregnation is less than or equal to the pore volume of the catalyst, typically results in poorer dispersion of the metal complex being impregnated compared to strong electrostatic adsorption. See, Miller et al, (2004) J. of Catalysis, 225:203-212.

### SUMMARY OF THE INVENTION

The present invention provides an effective method for preparing a highly dispersed, highly loaded platinum metal element such as platinum (Pt) on a carbon substrate such as conductive carbon black, which is commonly utilized in fuel cell electrodes. Impregnating the carbon black using a dry impregnation method is a simple and effective method of making catalysts. The present invention also provides a highly loaded carbon substrate having levels of at least 120 m² Pt/g Pt of highly dispersed platinum metal elements. The present invention also provides a highly loaded carbon substrate having levels of at least 120 m² Pt/g Pt of highly dispersed platinum metal elements.

More specifically, the invention provides a method for preparing particles of a platinum metal element on a carbon substrate. In a preferred embodiment method an aqueous solution of a platinum metal element complex, such as chloroplatinic acid, is prepared by dissolving the platinum metal element complex in an amount of water not exceeding the pore volume of the carbon substrate to be impregnated. If necessary, the pH of the aqueous solution is adjusted to a value of less than about 2, or, preferably, less than about 1. A carbon substrate is contacted with the aqueous solution and allowed to dry at ambient conditions. The platinum metal complex-loaded substrate is heated, preferably at a temperature of about 200° to about 300° C. under reducing conditions (e.g., in the presence of hydrogen) to form particles of a metal element on the carbon substrate. The platinum metal particles so formed are preferably about 15 to about 25 Å in diameter as determined by electron microscopy, CO Chemisorption and extended X-ray absorbance fine structure (EXAFS) measurements.

Another embodiment of this invention provides a carbon substrate having highly dispersed platinum metal elements of at least 120 m2 Pt/g Pt at platinum metal loadings of at least 20%. Yet another embodiment provides a carbon membrane or electrode having highly dispersed platinum metal elements of at least 120 m² Pt/g Pt at platinum metal loadings of at least 20%.

Preferred methods of the invention produce a highly dispersed, highly loaded platinum metal element on a carbon substrate that is useful as a fuel cell electrode. Preferred embodiment methods of the invention achieve relatively low cost and high yield. Dry impregnation is a single-step impregnation process that is easy and economical. Levels of impregnation can be tailored by the amount of platinum added to the aqueous solution from which deposition occurs.

### DETAILED DESCRIPTION OF THE INVENTION

U.S. Patent Publication No. 2004/0116286, entitled “Method for Preparing Highly Loaded, Highly Dispersed Platinum Metal on a Carbon Substrate,” achieves high metal dispersion on unoxidized carbon when the pH of the adsorption process is maintained at an optimal value with respect to the point of zero charge of the specific carbon being used. High loading is achieved only if the point of zero charge is determined in advance of the catalyst impregnation.

For the purpose of promoting an understanding of the principles of the invention, references will be made to the photographs illustrated in the drawings. It will, nevertheless, be understood that no limitations of the scope of the invention is thereby intended, such alterations and further modifications in the described method, and such further applications of the principles of the invention herein being contemplated as would normally occur to one skilled in the art to which the invention relates.

In many applications such as heterogeneous catalysts and fuel cell electrodes, small particles of a metal element are mounted, by numerous techniques, onto high surface area carbon “supports” or “substrates”. The present invention contemplates a method for preparing highly dispersed, highly loaded metal particles on various carbon substrates, including conductive carbon black, such as that commonly utilized in fuel cell electrodes. The phrase “highly dispersed metal element” or “highly dispersed platinum metal element” refers to the fraction of metal or platinum metal atoms that are in contact with the carbon support surface such that the larger the fraction or percentage, the larger the number of atoms and therefore metal particles that are in contact with the surface.

The work on carbon, as presented herein, is an unexpected result of an extension of studies of noble metal catalyst impregnation in which the adsorption of noble metal complexes of Pt(IV), Pt(II), Au(III), and Pd(II) onto alumina and silica supports were examined. Representative disclosures relating to those studies are reported in Regalbuto et al. (1999) J. Cat., 184:335-34; and Spieker and Regalbuto (2001) Chem. Eng. Sci., 56:3491-3504. The adsorption process in those systems thought to be essentially electrostatic. Anionic noble metal complexes are strongly adsorbed over a support surface that is positively charged, and cationic complexes are adsorbed over negatively charged surfaces.

A preferred embodiment method of the invention accomplishes platinum metal loading by dry impregnating a carbon substrate with an aqueous solution of a dissolved platinum metal element complex present at a pH value less than about 2 where the metal element complex is present as a metal halide. It has been found unexpectedly that high platinum group metal loading and good metal dispersion is achievable using dry impregnation of the platinum group complex. Dry impregnation utilizes an amount of water that is less than or equal to that required to fill the pores of the substrate.

Exemplary platinum metal element complexes include the complexes of platinum, palladium, osmium, ruthenium, rhodium, tin, copper and iridium. Although not technically platinum metal elements, tin and copper have been found to be useful, and are included in this group for the purposes of this invention. Specific anionic complexes include the halides (chlorides, bromides and iodides) and halohydroxoaquo forms, and particularly the chloro and chlorohydroxoaquo complexes such as PtCl₄²⁻, PtCl₆²⁻, PtCl₅²⁻, PdCl₄²⁻, [RhCl₄(H₂O)₂]⁻, [RhCl₅(H₂O)]²⁻, [IrCl₅(H₂O)]⁻, RhCl₆³⁻, IrCl₆³⁻, OsCl₆³⁻, and [RuCl₄(H₂O)₂]⁻. Cationic complexes typically include one or more nitrogen atoms contained in a monodentate, bidentate or tridentate ligand such as amine (NH3), pyridine (py), ethylenediamine (en), 1,3-propanediamine (pn),; 1,10-phenanthroline (phen), 2,2′-bypyridine (bipy) or diethylenetriamine (dien) and can also include aquo (H₂O) ligands to form an amminoaquo complex. Specific cationic complexes include [Ru(NH₃)₅(H₂O)]²⁺, [Ru(NH₃)₅(H₂O)]³⁺, [Ru(bipy)₃]²⁺, [Os(bipy)₃]²⁺, Rh(NH₃)₆³⁺, Ir(NH₃)₆³⁺, Pd(NH₃)₄²⁺, Pt(en)²⁺, Pd(py)₂²⁺, and [Pt(en)₂]²⁺. The concentration of platinum metal element complex in solution preferably ranges from about 10⁻⁴ to about to the greater of about 1 molar or the limit of solubility, and more preferably about 10⁻³ to about 10⁻¹ molar. Preferably, the weight of metal to be adsorbed determines the amount of complex that is added to the solution. The volume of water used in the solution is less than or equal to the pore volume of the carbon substrate.

Preferably the pH of the impregnating solution is less than about 2. More preferably, the pH is less than 1.5 and more preferably the pH is less than about 1.0. If concentrated chloroplatinic acid is used as the metal complex solution, the high acidity of the diprotic acid maintains a pH that approaches 0. However, the addition of an acid to reduce the pH is contemplated where a dilute CPA solution is used or where a different, less acid metal element complex is selected.

Pore volume of the carbon substrate is generally available from the manufacturer, or can be determined in the laboratory. Typical pore volumes are from about 5 ml to about 9 ml water per gram of carbon. Water is added to the carbon powder to the point of incipient wetness. At this point, a thick slurry is formed, but breaks apart when stirred. The amount of water used to make the impregnating slurry is equal to or less than the pore volume to be impregnated.

The weight % of the metal complex is determined from the desired number of moles of metal that is desired on the surface of the finished catalyst and the substrate surface area. Substrate surface area (m²/g) is multiplied by the desired moles of metal per substrate surface area unit (moles metal/m² carbon) and by the molecular weight of the metal being impregnated (g metal/mole metal) to give the weight of metal per unit weight of substrate. The weight percentage of metal in the finished catalyst is then calculated based on 1 gram of substrate.

While not wishing to be bound by theory, there is evidence that high metals dispersion is due to an interaction of the metal with the carbon substrate. When chloroplatinic acid is adsorbed onto carbon at low pH, the Pt⁺⁴ is reduced to Pt⁺². Since the carbon is the only other substance present, presumably the carbon is oxidized. This reaction may serve to anchor the metal to the substrate. Any metal that is reduced at low pH could be used to make a highly loaded, highly dispersed catalyst.

A contemplated carbon substrate has a surface area of about 100 to about 2500 m²/g. Illustrative carbon substrates having varying surface areas and PZC values are available commercially from a number of sources such as E-TEK (Somerset, N.J., USA), Cabot Corporation (Alpharetta, Ga. USA), ENSACO 350 from Earchem Europe S.A. (Belgium), TIMCAL America (Westlake, Ohio) and Norit Americas (Atlanta, Ga., USA). Exemplary carbon substrates and their PZC and surface area values are provided in the table below.

TABLE 1
Exemplary Carbon Substrates

| | Surface Area | |
|---|---|---|
| Carbon Substrate | (m.sup.2/g) | PZC Value |
| Timcal TIMREX.TM. | 300 | 4.8 |
| Cabot Vulcan XC-72 | 254 | About 8.5 |
| Ensaco.TM. 350 | 770 | More than 9.0 |
| Norit SX Ultra2 | 1200 | 9.0 |
| Norit KB-B | 1500 | 5.0 |
| Norit CA1 | 1400 | 2.5 |

After the metal complex solution is contacted with the substrate, it is allowed to dry, preferably overnight.

It has been found unexpectedly that high platinum group metal loading and good metal dispersion is achievable using dry impregnation of the platinum group complex. Dry impregnation utilizes an amount of water that is less than or equal to that required to fill the pores of the substrate. Dispersion of 120 m²/g metal on a carbon substrate is achievable, even at high metal loadings of 20-30%. Even higher dispersions of 125 m²/g metal, or even 130 m²/g metal are also obtainable using this impregnation technique. As shown in the Examples, dispersion of 150 m²/g metal was achieved on a high surface area carbon substrate.

Even though some chemical reduction may occur during adsorption of the metal complex, the catalyst is additionally reduced to remove a substantial amount of the metal ligands and to reduce the metal to its elemental state. The metal complex-loaded substrate so formed is heated, preferably at a temperature of about 200° to about 300° C. and more preferably at a temperature of about 225° to about 250° C. under reducing conditions (e.g., in the presence of hydrogen or other convenient reducing agent) to form particles of a platinum metal element on the carbon substrate. The platinum metal particles so formed are preferably about 15 to about 25 Å. across (in diameter) as determined by electron microscopy, CO Chemisorption or extended X-ray absorbance fine structure (EXAFS) measurements, and are more preferably about 15 to about 20 Å across. Unexpectedly and unlike alumina and silica supports, carbons are impregnable with high loading and high metal dispersion by dry impregnation of the carbon at low pH.

Details of the most common electrode preparation method can be found in U.S. Pat. No. 4,044,193 and Watanabe et al. (1987) J. Electroanal. Chem. 229:395-406. That method of electrode preparation includes up to eight separate and cumbersome steps involving Pt sulfite complexes and sols. In contrast, the present method contains only one step in place of the eight, and can utilize the most common source for dissolved platinum, chloroplatinic acid (CPA) or another readily available water-soluble platinum metal element family member salt or complex.

The carbon black with dry, reduced, impregnated metals is ready to be used in a fuel cell. The fuel cell is synthesized by any way known in the art that utilizes a carbon electrode. A preferred fuel cell is a proton exchange membrane (PEM) fuel cell. This technology was invented by General Electric in the 1950s and was used by NASA to provide power for the Gemini space project. Proton exchange membrane fuel cells are also known as polymer electrolyte membrane, solid polymer electrolyte and polymer electrolyte fuel cells. Proton exchange membrane cells operate at a temperature of around 80° C. At this low temperature the electrochemical reactions would normally occur very slowly so they are catalyzed by the thin layer of the platinum group metal on each electrode. In the following discussion, catalytic electrode assemblies are discussed for a PEM fuel cell, but it is understood that the impregnated carbon is useful in other types of fuel cells, including alkaline fuel cells, phosphoric acid fuel cells, direct methanol fuel cells and others as are known in the art.

The electrode in a PEM fuel is called a membrane electrode assembly (MEA). It is sandwiched between two field flow plates to create a fuel cell. These plates contain grooves to channel the fuel to the electrodes and also conduct electrons out of the assembly. The type of plates used is not critical to this invention, and any plates can be used that are known in the art. Each membrane electrode assembly is made up of a cathode, an anode and an electrolyte that transfers the cation from the anode to the cathode. Hydrogen fuel flows into the fuel cell to the anode and is split into hydrogen ions (protons) and electrons. Oxygen from the air is supplied to the cathode and combines with the electrons and the hydrogen ions to produce water. The reactions at the electrodes are summarized as follows:

Anode: 2H₂→4H⁺+4e⁻

Cathode: O₂+4H⁺+4e⁻→2H₂O

Overall: 2H₂+O₂→2H₂O+energy

In the PEM fuel cell, the preferred electrolyte is a thin polymer membrane, such as poly[perfluorosulphonic] acid, known as NAFION (DuPont, Wilmington, Del.). This material is permeable to protons, but does not conduct electrons. The hydrogen ions permeate across the electrolyte membrane to the cathode, while the electrons flow through an external circuit and generate power. Although NAFION is the preferred membrane, any polymer useful in fuel cells is suitable for use with the dry impregnated carbon.

The impregnated carbon is applied to the membrane by any method known to an artisan. Typical coating methods are known to be effective, including spray coating, knife coating, screen printing, such as seriography, and brush painting of a solution of impregnated carbon onto the membrane. The thickness of the coating varies with the platinum metal loading. This layer is cast with a homogenous ink that includes the carbon supported platinum catalyst and polytetrafluroethylene (PTFE) uniformly dispersed in a solution of ionomer. PTFE is optionally included in the cathode catalyst layer at a wt % sufficient to render the cathode catalyst material hydrophobic in nature on the oxygen side and to fill the free percolation volume of the contacting particles so that porosity is reduced. The concentration of PTFE in the cathode catalyst is from 5 to 42 wt % with the concentration range of 25 to 32 wt % being preferred.

After the membrane has been coated with the impregnated carbon, the membrane electron assembly is formed. An optional porous carbon backing is applied to the impregnated carbon layer. The porous carbon backing layers are comprised of a carbon paper or carbon cloth. The electrolyte is not part of the backing. From left to right the cross section of one MEA would go: flow channel, diffusion layer (or porous carbon backing), anode, PEM, cathode, diffusion layer, flow channel. Multiple MEAs are layered to make the “stack”.

An anode catalyst and the porous carbon backing layer, which are applied preferably via serigraphic printing to a graphite or carbon paper, are attached to the opposite side of the polymer electrode membrane. The anode catalyst comprises less PTFE as compared to the cathode catalyst. PTFE concentrations range from 5 to 20 wt % with 7 wt % being preferred. The carbon backing layers are preferably cast between the cathode catalyst layer or anode catalyst layer and porous graphitized paper layers using a homogenous ink containing conductive carbon black particles, dispersed ionomer and polytetrafluoroethylene.

PEM fuel cells have a number of attributes that make them ideal candidates for use in automotive applications and small domestic applications, such as replacements for rechargeable batteries. They operate at relatively low temperatures which allows them to start up rapidly from cold and have a high power density which makes them relatively compact. In addition, PEM cells work at high efficiencies, producing around 40-50 per cent of the maximum theoretical voltage, and can vary their output quickly to meet shifts in power demand. When completed, each cell produces around 0.7 volt. In order to generate a higher voltage, a number of fuel cells are combined in series to form a structure known as a fuel cell stack.

### EXAMPLE 1

### COMPARATIVE EXAMPLE

### Sea Impregnation of Carbon Black

Carbon black was impregnated with CPA solution. A 200 ppm solution of Chloroplatinic acid was prepared by adding the acid to water. The CPA solution was slightly basified with an amount of sodium hydroxide sufficient to maintain a pH of 2.9 after contact with a carbon substrate for one hour. The solution was contacted with BP 2000 carbon black at 500 m²/l for one hour to produce a catalyst having 0.3 g Pt/g catalyst. After contact, during which almost the entire amount of Pt complex was adsorbed, the carbon was filtered and dried overnight at 100° C. The dried catalyst was then placed in a flow reactor and reduced in pure flowing hydrogen for one hour at 200° C.

### EXAMPLE 2

### Dry Impregnation of Carbon Black

One gram of BP 2000 Carbon Black (500 m²/gm) (Cabot Corp., Alpharetta, Ga.) was mixed with 5 ml concentrated CPA solution. The CPA solution had a pH of about 0, and was absorbed into the pores of the carbon substrate. The substrate was then allowed to dry overnight at room temperature. The dried catalyst was then placed in a flow reactor and reduced in pure flowing H₂ for 1 hour at 200° C.

The products of examples 1 and 2 were compared using electron micrographs. Both electron micropgraphs show good dispersion of the Pt metal. Particles produced using dry impregnation appeared smaller, indicating better dispersion than the SEA impregnated substrate.

To verify this surprising result, an additional estimation of Pt particle size was made by the common method of CO Chemisorption. The calculated Pt dispersion, given as m²/Pt per gm Pt, is given in Table 2 for all carbon blacks tested. In three of the four cases, DI gave substantially higher CO chemisorption than SEA. The DI values of well over 100 m² Pt/gm Pt for 20-30 wt % Pt are well above the highest values reported in the literature.

TABLE 2
CO CHEMISORPTION FOR HIGH PT LOADING,
HIGH SURFACE AREA CARBON BLACKS

| | SA | wt % | Pt area (m² Pt/gm Pt) | |
|---|---|---|---|---|
| Sample | m²/gm | Pt | SEA at pH 2.9 | DI at pHᵢₙᵢₜ ≅ 0 |
| Ketjen 300 | 800 | 19 | 93 | 122 |
| Ketjen 600 | 1415 | 24 | 62 | 126 |
| BP 2000 | 1475 | 28 | 116 | 150 |
| Ensaco 350 | 795 | 19 | 112 | 108 |

With embodiments of the invention, Pt can be adsorbed over the commercially preferred carbon black for fuel cell electrodes, at high loading and with high dispersion. The metal is present at this stage, however, as a coordination complex, such as [PtCl₆]⁻². For use as an electrode or a catalyst, the ligands of the coordination complex should be removed and the metal should be reduced to its elemental state. In the catalysis industry, this is commonly called “catalyst pretreatment” or “catalyst finishing”, and typically consists of a high temperature oxidation (in air; calcining) followed by a high temperature reduction (in hydrogen). With embodiments of the invention, it is not necessary to carry out a calcining step when using a carbon support prior to reduction of the complex to its elemental state.

High dispersion obtained through the adsorption process disclosed herein is maintained during the catalyst pretreatment steps. Both alumina and silica supports onto which the Pt has been strongly adsorbed retain dispersion, which also holds true for carbon.

The results of utilizing the disclosed method for adsorption of a platinum metal element produces a higher loaded, more highly dispersed, better performing electrode/catalyst through a cost effective process. The foregoing description and the examples are intended as illustrative and are not to be taken as limiting. Still other variations within the spirit and scope of this invention are possible and will readily present themselves to those skilled in the art.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention. The exemplary claim that follows illustrates a preferred embodiment, and is not intended to indicate the broadest scope of the invention.

What is claimed is:

1. A method for preparing particles of a platinum metal element on a carbon substrate that comprises the steps of:
preparing an aqueous solution of a platinum metal element complex dissolved in an amount of water not exceeding the pore volume of a carbon substrate to be impregnated;
contacting the carbon substrate with the aqueous solution;
allowing the aqueous solution to be adsorbed into the carbon substrate; and
heating the carbon substrate with adsorbed aqueous solution under reducing conditions to form particles of a platinum metal element on said carbon substrate.

2. The method of claim 1 further comprising adjusting the pH of the aqueous solution to a value of less than about 2.

3. The method of claim 1 further comprising drying the carbon substrate prior to the heating step.

4. An impregnated carbon substrate prepared by the method of claim 1.

5. The impregnated carbon substrate of claim 4 wherein the platinum metal element complex of said preparing step is chloroplatinic acid.

6. The impregnated carbon substrate of claim 4 wherein the platinum metal element comprises at least one of the group consisting of platinum, palladium, osmium, ruthenium, rhodium, tin, copper and iridium.

7. The impregnated carbon substrate of claim 4 wherein the platinum metal element comprises platinum.

8. A carbon electrode comprising an impregnated carbon substrate prepared by the method of claim 1.

9. The carbon electrode of claim 8 wherein the carbon comprises carbon black.

10. The carbon electrode of claim 8 wherein the platinum metal element comprises at least one of the group consisting of platinum, palladium, osmium, ruthenium, rhodium, tin, copper and iridium.

11. An impregnated carbon substrate comprising:
a carbon substrate and
at least one platinum metal element impregnated onto said substrate at a loading of at least 20% based on the weight of the impregnated carbon substrate, and wherein said at least one platinum metal element is highly dispersed to at least 120 m² metal/g metal.

12. The impregnated carbon substrate of claim 11 wherein said platinum metal element is at least one of the group consisting of platinum, palladium, osmium, ruthenium, rhodium, tin, copper and iridium.

13. The impregnated carbon substrate of claim 11 wherein said at least one platinum metal element loading is at least 25%.

14. The impregnated carbon substrate of claim 11 wherein said at least one platinum metal element loading is at least 30%.

15. The impregnated carbon substrate of claim 11 wherein said carbon substrate is carbon black.

16. A carbon electrode comprising:
an anode;
an electrolyte; and
a cathode comprising a conductive carbon substrate and at least one platinum metal element impregnated onto said substrate at a loading of at least 20% based on the weight of the impregnated carbon substrate, and wherein said at least one platinum metal element is highly dispersed to at least 120 m² metal/g metal.

17. The carbon electrode of claim 16 wherein said platinum metal loading is at least 25%.

18. The carbon electrode of claim 16 wherein said platinum metal loading is at least 30%.

19. The electrode of claim 16 wherein said electrolyte comprises a proton exchange membrane.

20. The electrode of claim 19 wherein said impregnated substrate is coated onto each of two opposing sides of said proton exchange membrane.

21. The electrode of claim 19 wherein said proton exchange membrane comprises poly[perfluorosulphonic] acid.

22. The electrode of claim 16 wherein said platinum metal is dispersed to at least 120 m² metal/g.
